(19) United States
(12) Patent Application Publication
(10) Pub. No.: US 2014/0280289 A1
(43) Pub. Date: Sep. 18, 2014

(54) AUTOSUGGESTIONS BASED ON USER HISTORY

(71) Applicant: MICROSOFT CORPORATION, Redmond, WA (US)

(72) Inventors: DANIEL MARANTZ, Bellevue, WA (US); Aaron YUEN, Bellevue, WA (US); Parthasarathy GOVINDARAJEN, Bothell, WA (US); Yu-Ting KUO, Sammamish, WA (US); Arun SACHETI, Sammamish, WA (US)

(73) Assignee: MICROSOFT CORPORATION, Redmond, WA (US)

(21) Appl. No.: 13/797,116

(22) Filed: Mar. 12, 2013

(51) Int. Cl. G06F 17/30

(52) U.S. Cl. CPC G06F 17/30392
USPC 707/767

(57) ABSTRACT

Methods, systems, and computer-readable media for recommending completions for partial strings while a user is typing in characters of the partial strings are provided. A search engine executed by a server receives the partial string. In response, the search engine generates autosuggestions and user-specific completions. The user-specific completions are based on a history corresponding to the user. The user-specific completions are also associated with one or more URIs. The autosuggestions and user-specific completions are transmitted in display rank order to the user. The autosuggestions and user-specific completions are displayed in a dropdown box that allows the user to select a completion for the partial string. A URI corresponding to the user-specific completions is displayed based on user interaction with the user-specific completions include in the dropdown box.

### BACKGROUND

Conventional search engines permit users to locate relevant websites and other content. The search engine receives user submitted queries and returns search results that are responsive to the query. The search engine may log the queries submitted by the users to improve user experience with the search engine. Often, users need assistance when formulating the initial queries that are submitted to the search engine. Some search engines are configured to suggest queries that a user can submit based on the query logs maintained by the search engine.

An autosuggest component executed by the search engine may be implemented during query formulation. While a user is inputting initial characters associated with a search query, the search engine may receive potential completions to the initial characters from the autosuggest component. The conventional search engines may be configured to provide a query formulation interface that receives the initial characters. The autosuggest component may update the query formulation interface with the potential completions. The autosuggest component may display the potential completions in an area proximate to where the user is inputting the initial characters. For instance, the query formulation interface may be displayed to the user and may include a list of the potential completions in a display area below the initial characters. If the user executes the search query (either by manually inputting the desired search query or by selecting a potential completion), the search engine provides the user with a search engine results page (“SERP”).

The conventional search engines may implement autosuggest components that generate the potential completions based on a dictionary. The dictionary may include complete words or phrases. The dictionary is accessed to locate the words or phrases that complete the initial characters. The dictionary may include one or more terms from the query log. Accordingly, the potential completions may include logged queries that are complete words or phrases.

### SUMMARY

Embodiments of the invention suggest potential query completions and uniform resource identifiers to a user while the user is formulating (via voice, gesture, keyboard, or NUI) words of a search query. The uniform resource identifier (URI) may correspond to content previously interacted with by the user. The suggested search queries are based, in part, on a partial string received at a search interface of a search engine. The potential query completions and URIs are transmitted from the search engine to a client device used to formulate the partial string.

The client device receives the potential query completions and URIs before the user submits the query to the search engine. The client device may display the potential query completions to the user. In some embodiments, each potential query completion is associated with at least one URI. The at least one URI may be displayed to the user. In other embodiments, the at least one URI is displayed based on the user interaction (hover, mouse-over, stare, click, blink, etc.) events received at the client device. Based on the user interaction with one of the potential query completions, the client device may highlight a selected potential query completion and display a preview pane for at least one URI that the user visited during a previous search session that includes prior queries that match the selected potential query completion. The preview pane may be a canvas area, displayed during query formulation time, for extra information about the selected potential query completion. For instance, the preview pane may display a portion of content extracted from the URI. In other embodiments, the user interaction may automatically cause the client device to request and load the content associated with the at least one URI.

In one embodiment, the potential query completion may correspond to an entity. When the user interacts with the potential query completion that corresponds to an entity, the preview pane may include history information corresponding to the entity or any other information corresponding to the entity. The information corresponding to the entity may be products, advertisements, goods, or transaction information previously interacted with by the user. Additionally, potential entity completions may be associated with one or more hidden attributes or other relationships that are unintelligible in string format alone.

Accordingly, potential query completions and corresponding URIs, in one embodiment, may be displayed in a dropdown box that allows the user to select one of the potential query completions. The dropdown box may be displayed below a search engine's search interface that received the partial string from the user. The potential query completions include autosuggestions and user-specific completions. The autosuggestions are generated based on logs maintained by the search engine. The user-specific completions, on the other hand, are based on logs corresponding to the user. The potential query completions may be displayed in rank order in the area available for query autosuggestions, for example in the area under the search box.

This summary is provided to introduce a selection of concepts in a simplified form. The related concepts are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Embodiments of the invention are described in detail below with reference to the attached drawing figures, wherein:

FIG. 1 is a block diagram illustrating an exemplary computing environment suitable for implementing embodiments of the invention;

FIG. 2 is a component diagram illustrating an exemplary computing system that provides both user-specific completions and autosuggestions, in accordance with embodiments of the invention;

FIG. 3 is a user interface diagram illustrating an exemplary search interface for receiving partial strings and providing potential query completions and corresponding URIs, in accordance with embodiments of the invention;

FIG. 4 is another user interface diagram illustrating an exemplary search interface for receiving partial strings and providing potential completions, in accordance with embodiments of the invention;

FIG. 5 is another user interface diagram illustrating an exemplary user-specific completion and corresponding URIs, in accordance with embodiments of the invention;

FIG. 6 is another user interface diagram illustrating exemplary user-specific completions corresponding to an entity, in accordance with embodiments of the invention;

FIG. 7 is a logic diagram for a method of generating a list of potential query completions for a partial string, in accordance with embodiments of the invention; and

FIG. 8 is a logic diagram for a method of generating potential entity completions for a partial string, in accordance with embodiments of the invention.

### DETAILED DESCRIPTION

The subject matter of this patent is described with specificity herein to meet statutory requirements. However, the description itself is not intended to necessarily limit the scope of the claims. Rather, the claimed subject matter might be embodied in other ways to include different steps or combinations of steps similar to the ones described in this document, in conjunction with other present or future technologies. Although the terms “step,” “block,” or “component,” etc., might be used herein to connote different components of methods or systems employed, the terms should not be interpreted as implying any particular order among or between various steps herein disclosed unless and except when the order of individual steps is explicitly described.

Embodiments of the invention provide potential query completions to a client device while a user is providing characters of a search query at a search interface of a search engine. The potential query completions include user-specific completions and autosuggestions that are generated by the search engine based, in part, on the characters entered at the search interface. The user-specific completions are recommended phrases that are available to complete the characters received from the user and to form the search query based on a search or navigation history corresponding to the user when authorized by the user. The autosuggestions are recommended phrases that are available to complete the characters received from the user and to form the search query based on the search or navigation history of a search engine. The search engine may have search or navigation histories for a community of searchers. The potential query completions are presented on the client device before the user submits the search query to the search engine. In some embodiments, the potential query completions may include recently visited URIs corresponding to the one or more of the user-specific completions that are included in an area proximate to the partial string received at the search interface. This allows a user that is formulating the search query to quickly retrieve or preview prior websites or resources that the user previously interacted and that are similar to the characters provided by the user.

Additionally, embodiments of the invention update the search interface during query formulation to preview prior URIs included in the user history that correspond to the user-specific completions for the partial string. The search engine may rank one or more of the user-specific completions and URIs and provide the user-specific completions and URIs having the highest rank to the client device for display to the user as a potential query completion. When the user interacts with the potential query completions, the client device, in one embodiment, may reveal the one or more URIs if the selected potential query completion is a user-specific completion. In at least one embodiment, the user-specific completion may correspond to an entity. An entity is a person, animal, plant, place, organization, business, thing, or the like. When the user-specific completion includes prior entity queries, the client device may reveal products and additional information corresponding to the entity in the search interface.

As utilized herein, “entity queries” are queries directed to people, animals, plants, products, things, events, or locations and not documents rather the queries are for product searches (e.g., books, movie, game, music), people searches (e.g., expert, celebrity, friend), location searches, or business searches that may return one or more URIs for entity repositories (e.g., electronic phonebooks, electronic maps, electronic encyclopedias, electronic business directories, or electronic catalogues).

Having briefly described an overview of embodiments of the invention, an exemplary operating environment suitable for use in implementing embodiments of the invention is described below.

A client device (e.g., e-book, tablet, gaming system, or hand-held device) may execute one or more search applications or may access a search engine on a server to retrieve web results. In one embodiment, the client device is configured to receive potential query completions for partial strings entered in a search interface for the search application or search engines. The potential query completions may be displayed in rank order in a dropdown box. Based on the user interaction with the potential query completions in the dropdown box, content previews or URIs corresponding to the potential query completions may be displayed on the client device before the user issues a query to the search engine.

FIG. 1 is a block diagram illustrating an exemplary computing environment suitable for implementing embodiments of the invention. Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The embodiments of the invention may be described in the general context of computer code or machine-useable instructions, including computer-executable instructions such as program components being executed by a computer or other machine, such as a personal data assistant or other handheld device. Generally, program components including routines, programs, applications objects, components, data structures, and the like refer to code that performs particular tasks or implements particular abstract data types. Embodiments of the invention may be practiced in a variety of system configurations, including handheld devices, tablet computers, consumer electronics, general-purpose computers, specialty computing devices, etc. Embodiments of the invention may also be practiced in distributed computing environments where tasks are performed by remote-processing devices that are linked through a communications network.

As one skilled in the art will appreciate, the computing device 100 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows a server device to provide potential query completions for partial strings entered at the client device. The server is configured to generate autosuggestions and user-specific completions based on the partial string, user logs, and search engine logs. The server may, in an embodiment, provide a ranked list of user-specific completions or autosuggestions and corresponding URIs to the user of the client device.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component, such as a display device, to be an I/O component. Also, processors have memory. The inventors hereof recognize that such is the nature of the art and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. Computer-readable media can be any available media that is accessible by computing device 100 and includes both volatile and nonvolatile media, removable and non-removable media. Computer-readable media may comprise communication media and computer storage media.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

On the other hand, computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired data and that can be accessed by the computing device 100. In an embodiment, the computer storage media can be selected from tangible computer storage media like flash memory. These memory technologies can store data momentarily, temporarily, or permanently. Computer storage media excludes and does not include communication media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, a controller, such as, a stylus, a keyboard and a mouse, or a natural user interface (NUI), etc.

The NUI processes gestures (e.g., hand, face, body), voice, or other physiological inputs generated by a user. These inputs may be interpreted as partial strings, requests for selecting a potential query completion, or requests for interacting with a URI corresponding to the potential query completions. The input of the NUI may be transmitted to the appropriate network elements for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras such as stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Various aspects of the technology described herein are generally employed in computer systems, computer-implemented methods, and computer-readable storage media for, among other things, interacting with potential query completions. In one embodiment, a server executes user-specific completion and autosuggestion components that generate the potential query completions for a partial string created by the user. In one embodiment, the user-specific completions include URIs that may be displayed in chronological order based on timestamps indicating a most recent interaction of visit by the user.

An embodiment of the invention provides potential query completions as the user is providing a partial string to the search engine. The user enters the partial string via a client device. The partial string comprises at least one or more characters and may be fewer characters than any of the potential query completions. In other words, the partial string comprises any combination of characters and words entered into a search field before the search is submitted. The client device is connected to the search engine, in one embodiment, via a network. The search engine receives from the user-specific completion and autosuggestion components the generated potential query completions based on any one of: user logs or search engine logs.

FIG. 2 is a component diagram illustrating an exemplary computing system that provides both user-specific completions and autosuggestions, in accordance with embodiments of the invention. The computing system architecture 200 includes, among other things, servers 202, storage device 204, client device 206, and network 208. It is understood and appreciated by those of ordinary skill in the art that the computing system architecture 200 shown in FIG. 2 is merely an example of one suitable computing system and is not intended to suggest any limitation as to the scope of use or functionality of the embodiments of the invention. Nor should the computing system architecture 200 be interpreted as having any dependency or requirement related to any single module/component or combination of modules/components illustrated therein.

The cloud servers 202, storage device 204, and client device 206 are connected to each other and in communication with one another via a network 208. The network 208 may include, without limitation, one or more local area networks (LANs) and/or wide area networks (WANs). Such networking environments are commonplace in offices, enterprise-wide computer networks, intranets and the Internet.

Each of the cloud servers 202 and the client device 206 shown in FIG. 2 may be any type of computing device, such as, for example, computing device 100 described above with reference to FIG. 1. By way of example only and not limitation, each of the servers 202 and the client device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The servers 202 may include any type of application server, database server, or file server configurable to perform the methods described herein. In addition, the servers 202 may be dedicated or shared servers. One example, without limitation, of a server that is configurable to operate as the server 202 is a structured query language (“SQL”) server executing server software such as SQL Server 2005, which was developed by the Microsoft Corporation headquartered in Redmond, Wash.

The servers 202 may execute a search engine 202a and user-specific completion component 202b and autosuggestion component 202c. The search engine 202a is configured to provide a SERP in response to a query. The search engine 202a provides a query formulation interface where a user may enter a partial string. In turn, the search engine 202a receives the partial string as the user interacts with the client device 206.

The user-specific completion component 202b may receive a partial string from the search engine 202a. The user-specific completion component 202b may obtain a user history. In some embodiments, the user history may correspond to a user identifier associated with the user of the client device. The client device 206 may provide the user identifier with the partial string to the server 202 when the user has authorized sharing or collection of user history. Alternatively, the user history may be collected by the server 202 and stored in storage device 204. The user history may include, among other things, previous queries issued by the user, timestamps for when the user issues a query, navigation history of the previous queries, SERPs associated with one or more of the previous queries, dwell times for URIs included in the SERP, number of clicks for each URI within a search session, or number of visits to each URI within the search session. The user specific-completion component 202b identifies one or more previous queries that complete the partial string. The previous queries in the user history may be ranked based on whether the partial string matches the previous queries, whether URIs match the partial string, whether content extracted from the resource corresponding to the URIs match the partial string, whether the dwell times corresponding to one or more URIs in the search session for the previous queries is above a specific threshold (e.g., 30 seconds), whether the number of clicks on other URIs during the search session is below a specific threshold (e.g., 5 clicks), and whether the timestamps for the previous queries are within a threshold time period (48 hours) of when the search engine received the partial string. For each of the above conditions that is satisfied by the partial string, a rank score may be incremented by a specified value (e.g., 1). In some embodiments, the specified value varies based on weights assigned to the above conditions, which may allow certain conditions to influence the rank score more that other conditions. In one embodiment, the user-specific completion component 202b obtains the n (e.g., 4) highest ranking previous queries and provides them to the search engine 202a for transmission to the client device 206. The server 202 may also receive the URIs corresponding to the previous queries and the rank assigned by the user-specific completion component 202b. The URIs and assigned ranks are configured for transmission to the client device 206.

The partial string may be provided to both the user-specific completion component 202b and the autosuggestion component 202c. In certain embodiments the user-specific completion component 202b and the autosuggestion component 202c receive the partial string at the same time or nearly the same time. The autosuggestion component 202c may obtain the search engine history from storage device 204. In some embodiments, the search engine history may be a log of previous queries issued by a community of users or URIs interacted with by the community of users. The search engine history may also include, among other things, timestamps for when the query was issued, navigation history corresponding to the query, SERPs associated with one or more of the previous queries, dwell times for URIs included in the SERP, number of clicks for each URI within a prior session corresponding to the query, or number of visits to each URI within the prior session. The autosuggestion component 202c identifies one or more previous queries that complete the partial string. The previous queries in the search engine history may be ranked based on, among other things, whether the partial string matches the previous queries, whether URIs match the partial string, whether content extracted from the resource corresponding to the URIs match the partial string, whether the dwell times corresponding to one or more URIs in the search session for the previous queries is above a specific threshold (e.g., 30 seconds), whether the number of clicks on other URIs during the search session is below a specific threshold (e.g., 5 clicks), or whether the timestamps for the previous queries are within a threshold time period (48 hours) of when the search engine received the partial string. For each of the above conditions that is satisfied by the partial string, a rank score may be incremented by a specified value (e.g., 1). In some embodiments, the specified value varies based on weights assigned to the above conditions, which may allow certain conditions to influence the rank score more that other conditions. In one embodiment, the autosuggestion component 202c obtains the n (e.g., 4) highest ranking previous queries and provides them to the search engine 202a for transmission to the client device 206 along with the user-specific completions. The server 202 may also receive the URIs corresponding to the previous queries and the ranks assigned to the previous queries by the autosuggestion component 202c. The URIs and assigned ranks are configured for transmission to the client device 206 with the user-specific completions. In some embodiments, the URIs for the autosuggestions are ignored and not displayed by the client device 206. In one embodiment, the search engine 202a may remove duplicates contained within the user-specific completions and the autosuggestions and obtain the next highest ranked previous queries to replace the duplicates. Any autosuggestions that match one or more of the user-specific completions may be discarded by the search engine 202a.

Additional components of the servers 202 (not shown for clarity) may include, without limitation, a processing unit, an internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer storage media and communication media. In general, communication media enables each server to exchange data via a network, e.g., network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single unit, one skilled in the art will appreciate that the cloud servers 202 are scalable. For example, the server 202 may actually include a plurality of servers in communication with one another. Moreover, the storage device 204 may be included within the cloud servers 202 or client device 206 as a computer-storage medium. The single unit depictions are meant for clarity, not to limit the scope of embodiments in any form.

The storage device 204 is configured to store, among other things, search engine histories and user histories when authorization is received. The storage device 204 is accessible by the servers 202. In various embodiments, such information may include, without limitation, text, images, audios, information associated therewith, and the like, in association with various languages. In embodiments, the storage device 204 is configured to be searchable for one or more of the items stored in association therewith. It will be understood and appreciated by those of ordinary skill in the art that the information stored in association with the storage device 204 may be configurable and may include any information relevant to one or more applications. The content and volume of such information are not intended to limit the scope of embodiments of the invention. Further, though illustrated as a single, independent component, the storage device 204 may, in fact, be a plurality of storage devices, for instance a database cluster, portions of which may reside on the server 202, the client-user device 206, another external computing device (not shown), and/or any combination thereof.

As shown in FIG. 2, the client device 206 includes a user input module 210 and a presentation module 212. The client device executes one or more applications, which may include search interfaces. The one or more applications are interacted with via the user-input module 210 and application content is rendered via the presentation module 212. In one embodiment, the applications may be games, word processing files, e-books, etc. The user may interact with the applications and may issue queries that are preformed locally on the content of the client device 206 or the server 202. The client device may store the user history locally on the client device. The user history stored on the client device may include, among other things, searches performed for applications, within applications, and corresponding navigations to the applications or to content corresponding to the applications. When authorized by the user, the client device may share the locally stored user history with the server 202.

In some embodiments, one or both of the modules 210 and 212 may be implemented as stand-alone applications. These stand-alone applications may be downloaded from the cloud server 202. In other embodiments, one or both of the modules 210 and 212 may be integrated directly into the operating system of the client device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for receiving input. Typically, input is received via a user interface (not shown) associated with the client device 206 or the like. Upon receiving input, the presentation module 212 of the client device 206 is configured for presenting results, potential query completions, and the partial strings. Embodiments are not intended to be limited to visual display but rather may also include audio presentation, combined audio/video presentation, and the like.

In one embodiment, a client device is configured to present a search interface to the user. The user interacts with the search interface to enter a partial string. The partial string is displayed by the client device. In turn, the client device receives potential query completions for the partial string. The potential query completions may be presented in dropdown box associated with the search interface.

FIG. 3 is a user interface diagram illustrating an exemplary search interface 300 for receiving partial strings and providing potential query completions and corresponding URIs, in accordance with embodiments of the invention. The search interface 300 displayed on the client device includes an entry box 310 to present the partial string received from the user. The entry box 310 may be updated to a dropdown box when the client device provides the potential query completions (320, 330, 340).

The potential query completions include the user-specific completions 320 and autosuggestions 330. The potential query completions, in one embodiment, include tiles 340. The tiles may be rectangle or square graphical areas that represent one or more URIs included in the user history and corresponding to the previous queries identified as the user-specific completions. In one embodiment, the “tiles” are exposed when the user interacts with user-specific completions included in the dropdown box. The tiles 340 may be rendered to the right of a selected user-specific completion. The tiles 340, in one embodiment, are displayed in rank order or chronological order. The tiles 340 may include a resource identifier 341 (e.g., uniform resource locator, file path, or uniform resource identifier) and a timestamp 342 associated with the resource identifier 341 obtained from the user history. In at least one embodiment of the invention, the tiles 340 include selectable representations of the resource identifier 341 that may be activated to obtain content pointed to by the resource identifier 341. The timestamp 342, in certain embodiments, represents the most recent date and time that the user clicked, visited, or otherwise interacted with the content of the resource identifier 341. In certain embodiments, the tiles 340 may include a content preview (not shown) that allows the user to quickly preview content associated with the resource identifiers 341. This allows the user to avoid selecting or clicking on resource identifiers that the user intends to avoid opening and viewing content corresponding to the resource identifiers. If the user located the resource identifier of interest in one of the tiles 340, the user may select the resource identifier to obtain the relevant content.

Upon receiving a command indicating that a user is hovering on one of the potential query completions, the search interface is updated to highlight the potential query completion. In one embodiment, the potential query completions may also show a chevron when the user hovers over the potential query completion that is a user-specific completion 320. The tiles 340 corresponding to a hovered over user-specific completion are displayed for a specific period of time (e.g., 10 seconds).

The autosuggestions 330, in one embodiment, do not include the tiles 340. When the user hovers over the autosuggestions 330, the search interface may be updated to highlight the autosuggestion 330. In alternative embodiments of the invention, the autosuggestions may include tiles 340 that correspond to popular resource identifiers 341 selected by a community of users of the search engine. The resource identifiers 341 are popular because the number of clicks associated with the resource identifiers 341 is higher than the number of clicks associated with other resource identifiers previously included in the SERP for previous queries that support the autosuggestions. The resource identifiers 341 are associated with previous queries matching the autosuggestion.

In other embodiments, when the user selects but before the user provides any characters for the search query in the search interface, a computer system may update the search interface to include popular potential query completions included in the search log. In other words, once the user selects the entry box, the search interface may include popular user-specific completions or popular autosuggestions. The popularity for the user-specific completions may be based on the number clicks included in the user history. The popularity for the autosuggestions may be based on the number of clicks included in search engine history for a community of users.

FIG. 4 is another user interface diagram illustrating an exemplary search interface 400 for receiving partial strings and providing potential query completions, in accordance with embodiments of the invention. The search interface 400 illustrates two scenarios for presenting the potential query completions. The first scenario 410 is when the user first interacts with the entry box. The second scenario 420 is when the entry box receives the first letter of the partial string from the user.

When the partial string is empty, the search engine may update the search interface with popular potential query completions. The popular potential query completions include popular completions from user-specific completions or autosuggestions. For instance, a zero query list 411 may include popular prior queries from the user history. These popular user queries may be identified based on the number of times the user issued the query included in the user-specific completions and the number of times the user interacted with or visited a resource identifier corresponding to the user-specific completions. The popular search engine queries may be identified based on the number of users that submit the query to a search engine and the number of users that interacted with or visited one or more resource identifiers corresponding to the popular autosuggestion. The popular potential query completions are displayed in response to the empty partial string received at the search engine. In one embodiment, the popular autosuggestions and popular user-specific completions may be ranked based on the number of satisfied click-throughs corresponding to the autosuggestions and user-specific completions. A satisfied click-through is a click on a resource identifier where the user interacts with content linked by the resource identifier for a period of time. This is different from a simple click, which does not have a time component. The satisfied click-through indicates that the user was satisfied with the content corresponding to the search results and, by inference, that the search result is responsive to the autosuggestions or the user-specific completions.

When the partial string includes at least one character, the search engine may identify the potential query completions from those that match the partial string received from the user. For instance, the typing query list 421 may include previous queries from the user history or the search history that match the partial string. The match may be anyone of: a prefix match, a suffix match, or a concept match. The matching potential query completions are included in the typing query list 421, which is updated as the partial string changes. In one embodiment, the first query shown in either the zero (e.g., empty) query list 411 or typing query list 421 is a user-specific completion and the remaining entries are autosuggestions or user-specific completions that are interspersed according to rank.

In other embodiments, the graphical user interface includes URIs from a prior search performed by the user. The graphical user interface is updated with the dropdown box having the potential query completions and corresponding tiles. In one embodiment, the tile of the most popular user-specific completion is automatically displayed without requiring additional user interaction.

FIG. 5 is another user interface diagram illustrating an exemplary user-specific completion and corresponding URIs, in accordance with embodiments of the invention. The search interface 500 includes an entry box 510 that is updated with potential query completions 520 and tiles 530. The search interface 500 may include one or more search results 540 from a prior query processed by the search engine.

The potential query completions 520 include both autosuggestions and user-specific completions. In one embodiment, the tiles of the most popular user-specific completion are automatically displayed along with the potential query completions 520 in the search interface 500. The tiles 530 correspond to the resource identifiers included in the user history. In one embodiment, the tiles for the user-specific completion may be ordered based on matches between the partial string and the user-specific completion.

In some embodiments, the user-specific completions may correspond to prior entity queries issued by the user. The prior entity queries may have hidden attributes that are used to obtain content. The hidden attributes may correspond to dialogs or other interfaces that the user interacted with before obtaining the content corresponding to the resource identifier logged in the user history. The search engine may access the hidden attributes stored in the user history to access the content and to preview the content (if authorized by the user) in the tiles.

FIG. 6 is another user interface diagram illustrating exemplary user-specific completions corresponding to an entity, in accordance with embodiments of the invention. When the search engine determines that one or more of the user-specific completions corresponds to an entity, the search interface 600 may be updated to include tiles (610, 620, and 630) having resource identifiers corresponding to the entity. The other tiles may include the other resource identifiers included in the user history, where the content of the resource identifiers match the partial string or the user-specific completion.

In certain embodiments, the content of the resource identifiers corresponding to the entity may not match the partial string or the corresponding user-specific completion. The hidden attributes stored in the user history but not included in the user-specific completion may be used by the search engine to identify the resource identifiers previously accessed by the user when the prior query corresponding to the entity-based user-specific completion was issued by the user.

Entity-based user-specific completions allow the user to access prior queries and corresponding resource identifiers. The prior queries, in some embodiments, were specified using dialogs or other interfaces that contain special attributes or relationships required to access the content corresponding to the entities. The tiles (610, 620, 630) content may include images, products, multimedia, or documents previously accessed in response to a prior entity-based user-specific completion.

The prior query expressions, in one embodiment, for the entity may correspond to a dialog assistive user interface (not shown) that builds an annotated query having hidden attributes provided by the dialog. When the prior query expressions associated with the entity-based user-specific completion are unintelligible as a user-readable-keyword query, the search interface may only display a portion of the query that is user-readable as keyword queries instead of the complete annotated query in the list of potential query completions. The annotated query is executed by backend retrieval system associated with the resource identifier included in the user history.

In some embodiments, a resource identifier alone may not be sufficient to allow the search engine to obtain the content for inclusion in the tile for the potential query completion. The search engine may access one or more hidden attributes stored in the user history when authorized by the user. The search engine may rebuild the annotated query from the previous query and hidden attributes stored in the user history and issue this query to the back-end system.

Accordingly, the user may bypass the dialog when accessing the resource identifiers of the entity query by directly issuing the annotated query to the backend retrieval system identified by the resource identifier stored in the user history. The tiles (610, 620, 630) may include the content obtained from the backend retrieval system, in some embodiments, the back-end retrieval system may correspond to a third-party e-commerce store, where the user completed one or more purchase transactions for electronic content available through the Internet only.

For instance, a user may have previously accessed electronic content for Jackie Chan. The annotated query may be “Jackie Chan's Action Movies in the Chinese Language released after the year 2000” that specifies one or more conditions. Rather than identifying matching content in the user history having similar keywords, the annotated query may access a backend system (e.g., movie database or e-commerce store) to obtain movie titles that satisfy conditions included in the annotated query.

In most cases, the user does not provide the annotated query to the search interface. Rather, a dialog assists the user with formulating the necessary attributes (e.g. year, product type, actor, language) of interest and receives desired values (e.g., 2000, movies, Jackie Chan, Chinese) for the annotated query. The user history may store the annotated expression that is provided the back-end system.

The user history may also store resource identifiers to each movie include in the set provided by the backend system. In most embodiments, the user history stores the resource identifiers for the movies. However, in one embodiment, the user history may only store a resource identifier that is associated with the back-end system. Thus, the user history may include both “user friendly” text (e.g., values) and hidden metadata attributes (e.g., conditions). In some embodiments, the hidden metadata attributes may include authorization information like user name, password, gesture inputs, biometric information.

In an embodiment, the user history may store the annotated query as a combination of the user friendly “QueryText and “Attribute+Relationship” expressions, The QueryText may include any of the following: “Jackie Clan Movies Chinese released since 2000,” “Jackie Chan Action Mo ves Chinese released after 2000,” “Jackie Chan Movies released after 2000.” The hidden “Attribute+Relationship” expression may include any of the following; [ResultType: “Movie”], [Actor: “Jackie Chan”], [Genre: “Action”], [Language: “Chinese”], [ReleaseYear: >2000], or [Relationship: “Action in Movie”]. The search engine may use the hidden data and query text stored in the user history to access the backend system and obtain the content for inclusion in the tiles of the search interface displaying the potential query completions. In one embodiment, when at least n (e.g., four) tiles are not complete based on content obtained from the backend system, the user may include other wehpages or URIs included the search session and accessed close to when the dialog based formulation of the annotated query occurred in the user history. In some embodiments, the hidden data may include attributes, metadata, or values established by the user while interacting with a prior web page but the hidden data is not visually displayed to the user while interacting with the webpage.

In other embodiments, a search engine may execute logic to generate the appropriate autosuggestions and user-specific completions. The user-specific completions and autosuggestions are ranked based on the metrics included in the search engine history and user history, respectively. The client device receives the autosuggestions and user-specific completions for display in the search interface along with one or more tiles having URIs or content corresponding to the URIs of the potential query completions.

FIG. 7 is a logic diagram for a method 700 of generating a list of potential query completions for a partial string, in accordance with embodiments of the invention. The method initializes in step 701 on a server device configured to provide the list of potential query completions to a client device. In step 710, the server receives the partial string from the user. In one embodiment, the partial string is obtained from a keyboard or natural user interface that provides input to a search engine.

The server may generate autosuggestions for the partial string, in step 720. The autosuggestions generated by the server may be based on a query log having phrases that complete the partial string. In step 730, user history is obtained by the server. In turn, user-specific completions for the partial string are generated based on the user history, in step 740. The user-specific completions are augmented in step 750. The server may augment the user-specific completions with one or more uniform resource locators included in the user history.

In some embodiments, the augmented user-specific completions are generated from user history that may include any combination of the following: previous queries issued by the user, search engine result pages of the previous queries displayed to user, or one or more previous URIs interacted with by the user, timestamps for previous queries, etc. Furthermore, the user history may include a length of time for the user interactions with one or more previous URIs included in the history. In one embodiment, the length of time measures dwell time for content in one or more webpages interacted with by the user. In other embodiments, the length of time measures dwell time for the URIs corresponding to weblinks interacted with by the user and included in a prior search engine result page located in the history.

In further embodiments, the user history may also include timestamps that identify when the user interacted with the one or more webpages or weblinks included in the user history. The user interactions may include any one of: gesture, gaze, hover, click, drag, copy, save, e-mail, or print. The URIs stored in the user history may be associated with a number of visits by the user and a prior search engine result page rank of the URI when it was included in the previous search engine result page.

In step 760, the user-specific completions are ranked. The user-specific completions may be ranked based on the user history. For instance, the previous queries in the user history and URIs included in the user history may be ranked based on any one of chronological order of timestamps assigned to the URIs, number of visits to the URIs, or the previous search engine result page rank for the URIs that correspond to previous queries that are identified in the user-specific completions. In one embodiment, the server may consider whether the URIs in the history were “success” or “good,” The “good” rank may be based on the number of times the user visited the page. The “success” rank may be based on the length of time the user stayed on a page associated with the content. The rank for a URI and corresponding user-specific completion may be based on a blend of the good rank and the success rank. Alternatively, the blended rank may be based on the chronological order (e.g., timestamp of last interaction with the URI, or timestamp of most recent query having the user-specific completion), number of visits to the URI or within a session having the user-specific completion, and the dwell time corresponding to the URI returned during the session corresponding to the user-specific completion. The URIs are ranked, at least, based on time, frequency, and satisfaction. In some embodiments, the server may further augment the user-specific completions by including the ranked URIs, a content preview for the ranked URIs, a timestamp associated with prior user interaction with one or more included URI, or the number of visits for one or more included URIs in the augmented user-specific completion.

In step 770, the server transmits the user-specific completions and auto suggestions to the client device. The partial string may be part of one or more of the autosuggestions or user-specific completions transmitted to the client device. In certain embodiments, the partial string may be a group of characters inputted by the user in a search interface of the search engine and the partial string may be contained within one or more of the autosuggestions or user-specific completions. In one embodiment, the autosuggestions or augmented user-specific completions may begin with the partial string. In other embodiments, the autosuggestions or augmented user-specific completions do not begin with the partial string. For instance, the autosuggestions or augmented user-specific completions may end with the partial string.

The search engine may generate a search interface having a query box that is configured to display the autosuggestions and the augmented user-specific completions that are transmitted to the client device. In an embodiment, the augmented user-specific completions are highlighted and listed with the autosuggestions. In an alternate embodiment, the augmented user-specific completions are set apart from the autosuggestions. The server, in one embodiment, may limit the augmented user-specific completions to a specific number (e.g., any number greater than zero but less than ten).

In some embodiments, the transmitted user-specific completions may be the augmented user-specific completions that are configured to be interactive and to display the one or more URIs associated with the augmented user-specific completions in response to user interaction with the augmented user-specific completions. The augmented user-specific completions and the autosuggestions may be displayed before the user submits a query for processing by a search engine. In one embodiment, the augmented user-specific completions may be displayed in ranked order and before the autosuggestions. Alternatively, the augmented user-specific completions or autosuggestions may be ordered based on user dwell times included in the user history for the augmented user-specific completions or the average user dwell time included in the search engine history for the autosuggestions.

In one embodiment, either the augmented user-specific completions or the autosuggestions are selectable by the user for input in the search engine. For instance, upon receiving a hover action for at least one augmented user-specific completion, the server executing the search engine may transmit a preview of at least one URI included in the history for display in an input box of a search interface generated by the search engine. In one embodiment, the URIs or content corresponding to the user-specific completion and having the highest rank is displayed in the search interface without requiring user interaction.

In other embodiments, the augmented user-specific completions may be associated with hidden data. The hidden data may further refine the scope of the user-specific completions. The hidden data may correspond to values or metadata associated with previous forms or dialogs interacted with by the user before, or after, arriving at the one or more URIs included in the history. The hidden data, however, is not displayed on the search interface at the client device. The server may use a combination of the hidden data and query text corresponding to the user-specific completion to obtain products or goods that may be previewed in the search interface based on the user interaction with the augmented user-specific completion. The method terminates in step 771.

In further embodiments, a search engine may execute logic to generate potential entity completions for a partial string. The potential entity completion may be based on the user-specific completions and metrics included in user history. The search engine may obtain entity content from a back-end system using an annotated query that is formulated from the user history. The client device receives the entity-based user-specific completions for display in the search interface along with one or more tiles for the entity content obtained from the backend system.

FIG. 8 is a logic diagram for a method of generating potential entity completions for a partial string, in accordance with an embodiment of the invention. The method initializes in step 801. The server, in step 810, receives the partial string at a search interface of a search engine from a user. Before the partial string is submitted to the search engine, performing at least the following to identify the one or more potential entity completions.

In step 820, the server obtains the user history. The user history may include prior entity queries issued by the user. Among other things, the history may also include previous webpages visited or interacted with by the user. The entity queries, in one embodiment, are associated with one or more prior URIs for webpages that the user visited or interacted with during a prior search session. In step 830, prior entity queries are selected from the user history. The server may select one or more entity queries that complete the partial string.

The partial string may include a portion of a previous entity query included in the user history. The partial string may, in other embodiments, include a portion of text included in a webpage found in the user history and interacted with by the user. The partial string may, in further embodiments, include values for one or more fields completed by the user when interacting with the webpage.

In one embodiment, the user history is configured to store hidden attributes used to retrieve one or more URIs that provide the entity information. The hidden attributes may correspond to fields of a dialog or other interface that the user previously interacted with when visiting a webpage corresponding to a URI included in the history. Additionally, the hidden attributes correspond to metadata collected by fields or data entry boxes of the dialog or other interfaces, wherein the fields or data entry boxes were not visible to the user.

The server identifies potential matches between the partial string and previous entity queries, between the partial string and text included in the webpage interacted by the user during a search session having one of the previous entity queries, or between the partial string and one or more hidden metadata attribute or values corresponding to fields for the webpages interacted by the user during a search session having one of the previous entity queries.

In turn, the selection of prior entity queries from the potential matches may be based on, among other things, any combination of the following: matches between the partial string and the hidden attributes, timestamps included in the user history, recency of the prior entity query, length of stay associated with one or more webpages interacted with by the user during a search session corresponding to the prior entity query, or dwell times associated with search sessions having the entity queries.

The server transmits at least one entity query as a user-specific completion for the partial string in step 840. The user-specific completions are configured for display in the search interface. The user-specific completions are intermingled with one or more autosuggestions. Alternatively, the user-specific completions are configured to be displayed in higher display order than the one or more autosuggestions.

At the same time or after the user-specific completions are transmitted, the server may obtain content for tiles associated with an entity of the at least one entity query provided as the user-specific completion, in step 850. The server, in one embodiment, may recreate annotated entity queries based on the prior query text and hidden metadata attributes stored in the user history. The annotated query may be issued, by the server, to a back-end system to obtain content that is not directly available at the URI stored in the user history but that was previously interacted with by the user. The retrieved content, in one embodiment, may be previewed in the tile of the search interface.

In some embodiments, the user-specific completions include previewable content from the one or more URIs included in the history and associated with the one or more entity queries. The previewable content may be displayed based on user interaction with the user-specific completions For instance, the user-specific completions may be configured to display a chevron that is actionable to display the tiles having one or more URIS or other content previews. The method terminates in step 851.

It will be understood by those of ordinary skill in the art that the order of steps explained above are not meant to limit the scope of the embodiments of the invention in any way and, in fact, the steps may occur in a variety of different sequences within embodiments hereof. Any and all such variations, and any combination thereof, are contemplated to be within the scope of the embodiments of the invention. Alternative embodiments will become apparent to those of ordinary skill in the art to which the embodiments of the invention pertains without departing from its scope. Embodiments of the invention have been described to be illustrative rather than restrictive.

A search engine configured according to embodiments of the invention may provide a user with results from user history during query formulation. For instance, a user that is planning a hike may issue a query for “Mount Rainier hikes.” Upon receiving the results, the user may click on several results provided by the search engine. A few days later, the user may issue the same query to the search engine to continue his research. While typing the query “mount rainier hikes,” the search engine obtains the user history and provides the prior web results sites in a dropdown box of the search interface. These prior web results include the previous search results that the user interacted with. In turn, the user may click on the prior results included in the dropdown box to return to those sites.

Accordingly, the search interface of a search engine is updated to provide user-specific completions and autosuggestions to the user. The user-specific completions may include items stored in the user history. In some embodiments, the user-specific completions or autosuggestions may include advertisements. In one embodiment, the advertisements may be related to products that were viewed by the user in a previous search session. The advertisers, in one embodiment, may influence the autosuggestions that are included in the search interface based on advertiser bids and relevance of advertiser content to the partial string or the user-specific completions that are generated by the search engine.

In some embodiments, the user history may be shared across various platforms (Windows, X-box, Cloud, Mobile) if agreed to by the user. Thus, when the user is performing a search in any one of the platforms, the user history is updated and available to provide user-specific completions.

A computer system, in one embodiment, may include a client device, search engine, search engine log, and user history. The client device may interact with one or more user-specific completions provided by the search engine. The search engine log may store prior search and navigation histories associated with a search engine. On the other hand, the user history log may store prior search and navigation histories for a user.

The client device is configured to generate a partial string in an interface provided by the search engine, in an embodiment. The search engine is executed by a server device that generates the user-specific completions based on the user history and autosuggestions based on the search engine log. The server transmits a list having the user-specific completions and autosuggestions to the client device. The user-specific completions, in certain embodiments, are associated with one or more URIs included in the history.

Additionally, the client device receives the list and displays the list with an actionable indicator proximate to at least one user-specific completion in certain embodiments. The list is transmitted to the client device before the user submits a query that includes the partial string. The list is displayed in the interface provided by the search engine.

In at least one embodiment, user interaction with the indicator may cause the one or more URIs to be displayed on the client device. The user interaction may be received via a keyboard or a natural user interface associated with the client device. In one embodiment, when the one or more URIs are displayed, the client device may also render a preview of content corresponding to the one or more URIs.

The server, in certain embodiments, may also provide a rank for one or more of the potential query completions of the partial string. The server may receive the partial string from a user. The server generates user-specific completions based on a user history, as explained above. The server also generates autosuggestions based on a search engine log associated with the server.

In one embodiment, display order ranks are assigned to the user-specific completions and the autosuggestions based on any one or more of the following: timestamps for prior queries similar to the autosuggestions, timestamps for prior queries similar to the user-specific completions, dwell times during prior sessions having the queries similar to the autosuggestions, dwell times during user sessions having the queries similar to the user-specific completions, number of visits to URIs during prior sessions having the queries similar to the autosuggestions, number of visits to URIs during user sessions having the queries similar to the user-specific completions, number of clicks on URIs during user sessions having the queries similar to the user-specific completions, number of clicks on URIs during prior sessions having the queries similar to the autosuggestions, matches between the partial string and the autosuggestions, or matches between the partial string and the user-specific completions.

A list of the user-specific completions, autosuggestions, and corresponding display order ranks are transmitted to the client device from the search engine, in one embodiment. The list is transmitted to the user before the user submits a query that includes the partial string. In one embodiment, the user-specific completions are clustered together in the list displayed on the client device. The client device may display the cluster of user-specific completions in a display order that is higher than the autosuggestions received from the search engine.

From the foregoing, this innovation is one well adapted to attain all the ends and objects set forth above, together with other advantages which are obvious and inherent to the system and method. It should be understood that certain features and subcombinations are of utility and may be employed without reference to other features and subcombinations. This is contemplated by and is within the scope of the claims.

The technology claimed is:

1. One or more computer-readable media having computer-executable instructions embodied thereon that when executed by a computing device perform a method of generating a list of potential query completions for a partial string, wherein the list is based on history for a user, the method comprising:
generating autosuggestions for the partial string provided by the user;
generating user-specific completions for the partial string based on a history associated with the user;
augmenting the user-specific completions with one or more uniform resource identifiers (URIs) included in the history; and
transmitting the autosuggestions and the augmented user-specific completions to the user, wherein the augmented user-specific completions are configured to be responsive to user interaction by triggering a display of the one or more URIs associated with the augmented user-specific completions when the user interacts with the augmented user-specific completions.

2. The media of claim 1, wherein the partial string is a part of one or more of the autosuggestions or user-specific completions.

3. The media of claim 1, wherein the partial string is a group of characters representing input from the user.

4. The media of claim 1, wherein the augmented user-specific completions are highlighted and listed with the autosuggestions.

5. The media of claim 1, wherein the augmented user-specific completions are limited to a predetermined number.

6. The media of claim 1, wherein the augmented user-specific completions are associated with data that further refines the scope of the user-specific completions but the data is not displayed.

7. The media of claim 6, wherein the data corresponds to values or metadata associated with previous forms or dialogs interacted with by the user prior to arriving at the one or more URIs included in the augmented user-specific completions.

8. The media of claim 1, wherein the autosuggestions are generated from a query log having phrases that complete the partial string.

9. The media of claim 1, wherein the autosuggestions or augmented user-specific completions begin with the partial string.

10. The media of claim 1, wherein the augmented user-specific completions are generated from the history that includes any combination of the following: previous queries issued by the user, search engine result pages of the previous queries displayed to the user, or one or more previous URIs interacted with by the user.

11. The media of claim 10, wherein the history includes a length of time for the user interactions with one or more previous URIs included in the history.

12. The media of claim 10, wherein the history includes a timestamp that identifies when the user interacted with one or more webpages or URIs.

13. The media of claim 10, wherein the user interactions include at least one of: gestures, gaze, hover, click, drag, copy, save, e-mail, or print.

14. The media of claim 12, further comprising:
ranking the user-specific completions based on the history to establish a display order for the user-specific completions, wherein the ranking of the user-specific completions based on the history comprises ranking the previous queries in the history and URIs included in the history based on one or more of chronological order of timestamps assigned to the URIs, number of visits to the URIs, or previous search engine result page rank.

15. The media of claim 1, wherein the augmented user-specific completions and the autosuggestions are displayed before the user selects a query and enters a command for a search engine to process the selected query.

16. The media of claim 15, further comprising: upon receiving a user interaction for at least one augmented user-specific completion, transmitting, by the search engine, a preview of at least one URI included in the at least one augmented user-specific completion for display in an area corresponding to an input box of a search interface generated by the search engine.

17. The media of claim 15, wherein the augmented user-specific completions are ordered based on user dwell times included in the history.

18. One or more computer-readable media storing computer-executable instructions for performing a method of generating potential entity completions for a partial string, the method comprising:
receiving the partial query at a search interface of a search engine from a user;
before the user selects the partial query and enters a command for the search engine to process the selected partial query performing at least the following:
obtaining a history for the user, wherein the history includes prior entity queries;
selecting one or more entity queries that complete the partial query, wherein the entity queries are associated with one or more prior URIs that the user interacted with; and
transmitting the one or more entity queries as user-specific completions for display in the search interface, wherein the user-specific completions include previewable content from the one or more URIs included in the history and associated with the one or more one or more entity queries.

19. The media of claim 18, wherein the user-specific completions are configured to be displayed in higher display order than the one or more autosuggestions.

20. The media of claim 18, wherein the partial query includes a portion of a previous query included in the history for the user.

21. The media of claim 18, wherein the partial query includes a portion of text included in a webpage included in the history and interacted with by the user.

22. The media of claim 21, wherein the partial query includes values for one or more user interface fields previously completed by the user when interacting with the webpage.

23. The media of claim 22, wherein the history includes attributes used to identify one or more URIs pointing to content having the entity information and the attributes corresponding to fields of a dialog or other interface that the user previously interacted with when visiting a webpage corresponding to a URI included in the history.

24. The media of claim 23, wherein the attributes correspond to metadata collected by fields or data entry boxes of the dialog or other interfaces

25. The media of claim 24, wherein the entity queries are selected based on matches between the partial string and the attributes.

26. The media of claim 18, wherein the entity queries are selected based on at least one of timestamps included in the history, recency, length of stay associated with one or more webpages interacted with by the user, or dwell times associated with search sessions having the entity queries.

27. The media of claim 18, wherein the user-specific completions are configured to display an icon that is configured to reveal the one or more URIs in response to user interaction with the icon.

28. The media of claim 18, wherein the history includes previous webpages visited by the user.

29. The media of claim 18, further comprising ranking potential entity completions for the partial string by:
assigning a display order rank to the user-specific completions based on one or more of the following: timestamps for prior queries similar to the user-specific completions, dwell times during user sessions having the queries similar to the user-specific completions, number of visits to URIs during user sessions having the queries similar to the user-specific completions, number of clicks on URIs during user sessions having the queries similar to the user-specific completions, or matches between the partial string and the user-specific completions; and
transmitting a listing having the user-specific completions and corresponding display order ranks.

30. A computer system, the system comprising a log having prior search and navigation history associated with a search engine, a history log having prior search and navigation history for a user; and a device configured to generate a partial query in an interface provided by the search engine:
the search engine is implemented by a server device configured to generate user-specific completions based on the history and autosuggestions based on the log and to transmit a list having the user-specific completions and autosuggestions to the client device, wherein the user-specific completions are associated with one or more URIs included in the history; and
the client device is further configured to receive the list and to display the list with an actionable icon proximate to at least one user-specific completion, wherein user interaction with the icon causes the one or more URIs to be displayed on the client device.

31. The system of claim 30, wherein the list is transmitted to the client device before the user submits a query that includes the partial query.

32. The system of claim 30, wherein the list is displayed in the interface provided by the search engine.

33. The system of claim 30, wherein displaying the one or more URIs includes rendering a preview of content corresponding to the one or more URIs.
